(19) United States
(12) Patent Application Publication
(10) Pub. No.: US 2005/0083788 A1
(43) Pub. Date: Apr. 21, 2005

(54) Extensible band for a watch

(76) Inventor: Terresa B. Ogletree, Kettering, OH (US)

Correspondence Address: Robert E. Cannuscio, Esq.;Drinker Biddle & Reath LLP, One Logan Square, 18th and Cherry Streets, Philadelphia, PA, 19103-6996, US

(21) Appl. No.: 10/690,111

(22) Filed: Oct. 21, 2003

(51) Int. Cl. G04B 37/00

(52) U.S. Cl. 368/282

(57) ABSTRACT

A band for a watch includes an internal core of elastic material and an outer cover enclosing the internal core. Opposite end portions of the internal core are reversed upon themselves to define loops for securing the watchband to band-securing structure of a watchcase to form a closed loop for attachment to a user's wrist. The outer cover may be made from a fabric material and define gathered portions of the fabric. The loops receive retainers dimensioned for receipt within recesses in spaced supports of a watchcase. The watchband may be included in a set of articles with a hair band also including an internal core and outer cover. The outer covers of the set of articles have similar colors or present patterns that are recognizable as being included in a common category to visually indicate that the articles belong together in a set.

### FIELD OF THE INVENTION

The present invention relates to watches and more particularly to a band for securing a watch to a wearer's wrist.

### BACKGROUND OF THE INVENTION

Known watches include a case adapted to house a mechanism such that a timekeeping display is presented by the watch. Known watches also include a watchband secured to the case and adapted for attachment of the watch to a wearer's wrist to facilitate presentation of the timekeeping display to the wearer. The watchband may comprise a single band secured at opposite ends to the watchcase or, alternatively may comprise separate band portions secured to the watchcase and adapted for engagement to each other to form a closed loop with the watchcase.

Known watchbands are made from leather, plastic and metal. Watchbands of metal incorporate a variety of constructions, including bracelet-like configurations having links interconnected in a chain or elements pivotably connected to each other at their ends. Watchbands may also include metal elements interconnected by biasing members to provide for relative extension or contraction of the resulting band.

A variety of means are known for attaching separate watchband portions to each other. Watchbands may include an attachment ring at the terminal end of one band portion adapted for receiving the other band portion. The separate band portions are secured to each other by prong carried by the first band portion that is received in one of spaced openings in the second band portion. Alternatively, the second band portion may carry adjacent sections of hook and loop material that are engageable when the second band portion is folded upon itself around the attachment ring of the first band portion. It is also known to secure a clasp mechanism to terminal ends of separate watchband portions, the clasp mechanism having pivotably interconnected segments to provide for enlargement of a closed loop defined by the watchcase, the watchband portions and the clasp mechanism

Known watches include support structure located at each of opposite sides of the watchcase for securing a watchband to the watch. The watchband support structure includes spaced supports at each side of the watchcase having recesses aligned with each other across the space defined between the supports. The watchband support structure also includes retainer members each having telescoping pins at opposite ends of the retainer member adapted for receipt within the recesses of the supports. The collapsible pins are biased toward an extended condition for securing the retainer members to the watchband supports.

### SUMMARY OF THE INVENTION

According to one aspect of the invention, an elongated band for a watch includes an internal core of elastic material and an outer cover enclosing the internal core. Opposite end portions of the internal core are reversed upon themselves to define loops for securing the watchband to band-securing structure of a watchcase such that the watchband and watchcase collectively define a closed loop for attachment to a user's wrist. Each of the terminal end portions of the internal core is secured in its looped configuration, preferably by stitching. Preferably, the outer cover is made from a fabric material and defines gathered portions of the fabric material.

According to one embodiment of the invention, each of the loops defined at the ends of the watchband receives a retainer having ends dimensioned for receipt within recesses formed in spaced supports secured to an end of a watchcase. Preferably, each retainer includes a central body portion and pins received by each of opposite ends of the central body portion.

According to another aspect of the invention, a set of apparel articles includes a watchband and a hair band, each comprising an internal core of an elastic material and an outer cover enclosing the internal core. Preferably, the outer covers are made from a fabric material and define gathered portions of the fabric material. The outer covers of the watchband and the hair band have similar colors or present patterns that are recognizable as being included in a common category to visually indicate that the watchband and the hair band belong together in a set of articles.

According to one embodiment of the invention, the outer covers of the watchband and hair band of the set of articles present identical patterns.

### BRIEF DESCRIPTION OF THE DRAWINGS

FIG. 1 is a front view of a watch having a watchband according to the present invention.

FIG. 2 is a side view of the watch of FIG. 1.

FIG. 3 is an exploded view showing one end of the watchband and a watchband retainer of FIG. 1 removed from the watchcase.

FIG. 4 is a sectional view of one end of the watchband of FIG. 3 taken along the lines 4-4 of FIG. 3.

FIG. 5 illustrates a person having a watch according to the present invention and a hair band, the watchband of the watch and the hair band bearing a matching pattern.

### DETAILED DESCRIPTION OF THE DRAWINGS

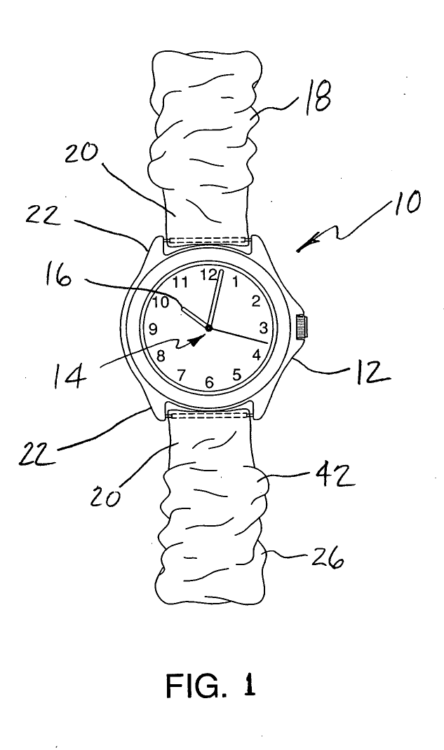

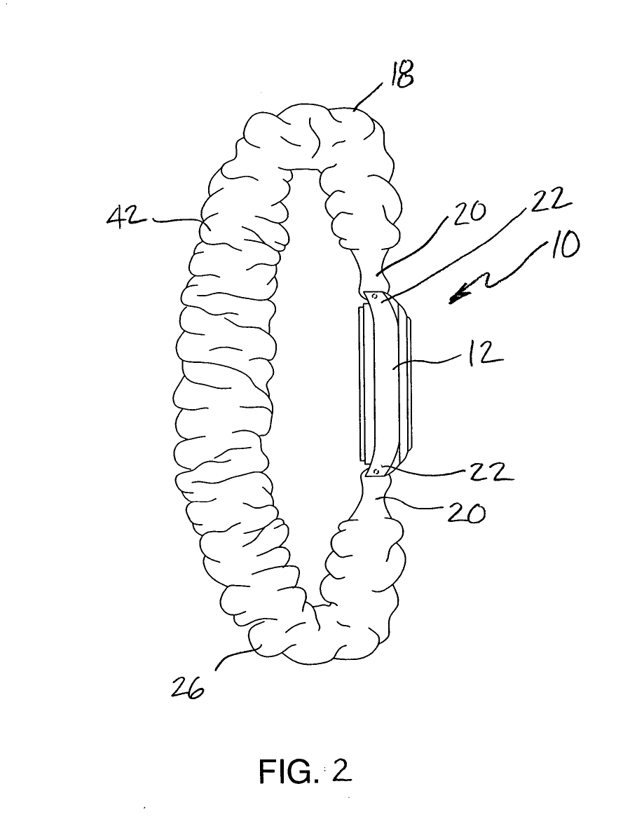

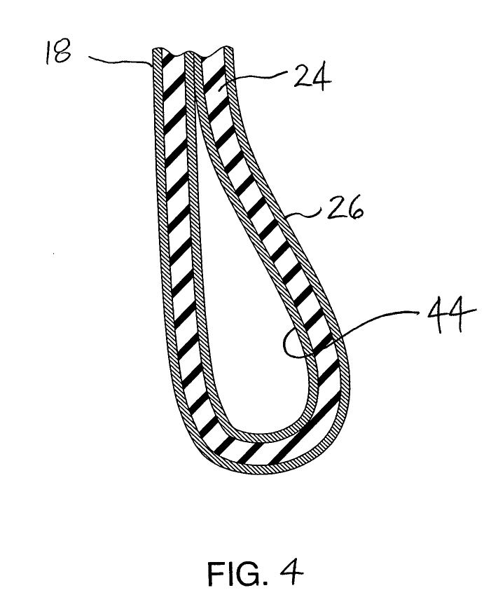

Referring to the drawings where like numerals identify like elements, there is illustrated in FIGS. 1 and 2 a watch 10 according to the present invention. The watch 10 includes a watchcase 12 housing a timekeeping mechanism 14. The timekeeping mechanism 14 is supported within the watchcase 12 such that a time-display portion 16 is presented. The watch 10 also includes a watchband 18 having opposite ends 20 secured to the watchcase 12 at opposite ends 22 of the watchcase for attachment of watch 10 to a wearer's wrist. As described below in greater detail, the watchband 18 incorporates a composite construction including an extensible internal core portion 24 (FIG. 4) and an outer cover portion 26 enclosing the core portion.

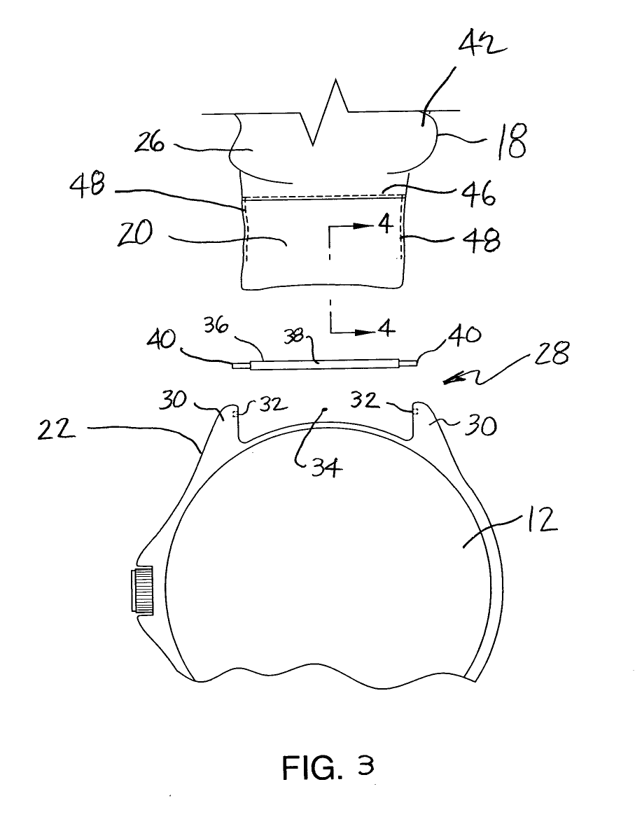

Referring to FIG. 3, one of the ends 20 of the watchband 18 is shown removed from the associated end 22 of the watchcase 12 to illustrate watchband-securing structure 28 of watch 10. The watchband-securing structure 28 includes a pair of supports 30 located at each of end 22 of the watchcase 12. As shown, each of the supports 30 includes a recess 32 that is aligned with the recess 32 of the other support 30 across a space 34 defined between the supports 30.

A retainer 36 is included at each end 22 of the watchcase 12 for securing the watchband 18 to the watchcase 12. The retainer 36 includes an elongated central body 38 and pins 40 telescopingly received in opposite ends of the central body 38. The pins 40 are biased outwardly from the central body 38 by internal springs (not shown) towards the extended condition of FIG. 3 in which the retainer 36 has been removed from the spaced supports 30 at the 22 of watchcase 12. Retainers such as retainers 36 are per se known for securing watchbands to watches and, therefore, no further description of their construction is required.

As shown in FIG. 3, the retainer 36 in its extended condition has an overall length that is longer than the space 34 between the supports 30 of the pair of supports. Compressive forces applied to opposite ends of the 36 causes the pins 40 to telescope inwardly with respect to the central body 38 to a retracted condition. The retraction of the pins 40 results in shortening of the overall length of retainer 36 to a length that is shorter than that of space 34. The shortening of the retainer 36 allows the retainer 36 to be located between the supports 30 for receipt of the pins 40 in the aligned recesses 32.

Referring to FIG. 4, the watchband 18 of the present invention incorporates a composite construction including an internal core 24 and an outer cover 26 enclosing the internal core 24. The internal core 24 comprises a strip that is made from and elastic material to provide for increase in the length of the core 24 under tensile load applied to the core. The outer cover 26 is made from a fabric material. As shown in FIGS. 1 and 2, the outer cover 26 defines gathered, or bunched, portions 42 of throughout a majority of the watchband 18.

The gathered portions 42 of the outer cover 26 facilitate the elongation of the internal core 24 under applied tensile load for a corresponding increase in the size of a closed loop defined by watchband 18 and watchcase 12. Increase in the closed loop in this manner facilitates placement of watch 10 on a wearer's wrist and removal of the watch 10 therefrom. The above-described composite construction for watchband 18, including an elastic core 24 and an outer cover 26 having gathered fabric portions, is similar to that of hair bands marketed by L&N Sales and Marketing, Inc. under the trademark SCUNCI® and shown in U.S. Des. Pat. No. 292,030 issued Sep. 22, 1987.

The watchband end 20 of FIG. 3 is shown in section in FIG. 4. Terminal end portions of the internal core 24 and outer cover 26 of watchband 18 are reversed upon themselves to define loops 44 at each of the ends 20 of the watchband 18. The watchband ends 20 are secured in the looped configuration shown in FIG. 4 by lines of stitching 46, 48 respectively extending laterally across the wristband 18 and longitudinally along each of opposite sides of the wristband. As shown in FIG. 3, the longitudinal stitching lines 48 end short of the terminal end of wristband 18. This serves to maintain access to the loops 44 for receipt of the retainers 36 within the loop to provide for connection of the watchband ends 20 to the spaced supports 30 when the pins 40 are received in the recesses 32 of the spaced supports 30.

It is not a requirement that stitching be used to secure the watchband ends 20 in their looped configurations. Any suitable means of securing the ends 20, such as gluing for example, could alternatively be used. It is also not a requirement that both of the internal core 24 and outer cover 26 be formed into a looped configuration. It is conceivable for example that the internal core could be reversed upon itself at its ends to define loops which are then enclosed within the outer cover. Access to the loop, for a retainer or other band-securing structure, could be provided by aligned openings on opposite sides of the enclosing cover of the composite watchband.

Referring again to FIG. 1, the display portion 16 of the timekeeping mechanism 14 shown includes rotating hands and a numbered face. The present invention, however, is not limited to any particular watch design and could be incorporated in watches having other time keeping mechanisms and displays such as electronic watches having liquid crystal displays.

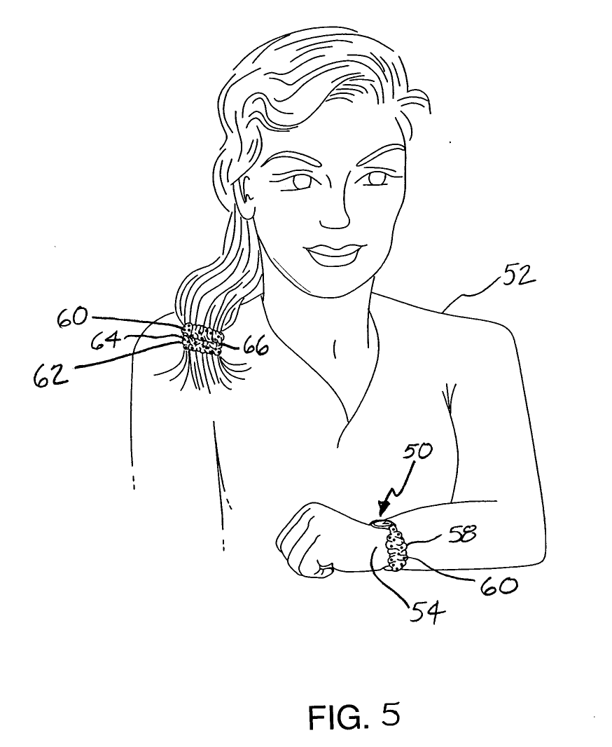

Referring to FIG. 5, a watch 50 similar in construction to watch 10 of FIGS. 1-4 is shown attached to the wrist 54 of a wearer 52. The watch 50 is similar in construction to the watch 10 of FIGS. 1-4 and includes a watchband 56 having an outer cover 58. The outer cover 58 of the watchband 56 presents a pattern design 60. As shown in FIG. 5, the wearer 52 of watch 50 also is wearing a hair band 62 in her hair. The hair band 62 is similar in construction to the above-mentioned hair bands marketed under the SCUNCI® trademark and shown in U.S. Des. Pat. No. 292,030 and includes an outer cover portion 64 defining gathered material portions 66.

As shown in FIG. 5, the outer cover 64 of the hair band 62 incorporates the same pattern 60 of the watchband 56 of watch 50 such that the watch 56 and hair band 62 for coordinated parts of a set 68. It is not required, however, that the watch and hair band of a coordinated set include identical patterns on the respective outer cover portions. The watch and hair band of a coordinated set, for example, could incorporate matching colors on the outer covers. Alternatively, the watchband and hair band could incorporate non-identical patterns or designs that are, nonetheless, recognizable as included in a common category of elements. Examples of such recognizable categories include, for example, flowers, animals, patriotic symbols, sports insignias, etc.

The foregoing describes the invention in terms of embodiments foreseen by the inventor for which an enabling description was available, notwithstanding that insubstantial modifications of the invention, not presently foreseen, may nonetheless represent equivalents thereto.

1. A watch comprising:
a watch mechanism including a timekeeping display;
a watchcase supporting the watch mechanism such that the timekeeping display is presented to a user;
an elongated band having opposite ends and including an internal core of elastic material and an outer cover, each end of the internal core defining a loop; and
band-securing structure secured to the watchcase at opposite ends thereof, the band-securing structure engaging the ends of the band to secure the band to the watchcase such that the band and watchcase collectively define a closed loop for attachment of the watch to a user's wrist.

2. The watch according to claim 1, wherein the outer cover is made from a fabric material and defines gathered portions of the fabric material.

3. The watch according to claim 1, wherein opposite terminal end portions of the internal core are reversed upon themselves to define the loops.

4. The watch according to claim 3, wherein each of the terminal end portions of the internal core is secured in its looped configuration by at least one line of stitching.

5. The watch according to claim 1, wherein the band-securing structure includes a pair of spaced supports at each end of the watchcase and a retainer received within each of the loops of the band, each retainer secured to one of the pairs of spaced supports.

6. The watch according to claim 5, wherein each retainer has opposite ends received within aligned recesses in the spaced supports of the associated pair of supports.

7. The watch according to claim 6, wherein each retainer includes a central body having opposite ends and pins received in opposite ends of the central body, the pins dimensioned for receipt within the recesses in the spaced supports.

8. The watch according to claim 3, wherein the outer cover includes opposite terminal end portions enclosing the terminal end portions of the internal core, and wherein the terminal end portions of the outer cover are reversed upon themselves together with the terminal end portions of the internal core.

9. A band for securing a watch to a wearer's wrist, the band comprising:
an extensible strip of an elastic material forming an internal core portion of the band; and
a cover enclosing the core portion,
the internal core portion having opposite terminal ends each defining a loop adapted for engagement with an end of a watchcase.

10. The watch-securing band according to claim 9, wherein the cover is made from a fabric material and defines gathered portions of the fabric material.

11. The watch-securing band according to claim 9, wherein opposite terminal end portions of the internal core are reversed upon themselves to define the loops.

12. The watch-securing band according to claim 11, wherein each of the terminal end portions of the internal core is secured in its looped configuration by at least one line of stitching.

13. The watch-securing band according to claim 11, wherein the outer cover includes terminal end portions enclosing the terminal end portions of the internal core, and wherein the terminal end portions of the outer cover are reversed upon themselves together with the terminal end portions of the internal core.

14. A set of apparel articles comprising:
an elongated band having opposite ends adapted for engagement with band-securing structure of a watch; and
a hair band defining a closed loop,
each of the watchband and the hair band comprising an internal core of an elastic material and an outer cover enclosing the internal core, the outer covers of the watchband and the hair band having similar colors or presenting patterns that are recognizable as being included in a common category to visually indicate that the watchband and the hair band belong together in a set of articles.

15. The set of articles of claim 14, wherein the outer cover of each of the watchband and the hair band are made from a fabric material and define gathered portions of the fabric material.

16. The set of articles of claim 14, wherein the outer covers of the watchband and the hair band present identical patterns.
